(19) United States
(12) Patent Application Publication
(10) Pub. No.: US 2010/0164939 A1
(43) Pub. Date: Jul. 1, 2010

(54) DISPLAY AND COMMUNICATION METHOD THEREOF

(76) Inventor: Sun-Man So, Gwanak-gu (KR)

Correspondence Address: SHERR & VAUGHN, PLLC, 620 HERNDON PARKWAY, SUITE 320, HERNDON, VA, 20170, US

(21) Appl. No.: 12/648,224

(22) Filed: Dec. 28, 2009

(30) Foreign Application Priority Data
Dec. 29, 2008 (KR) 10-2008-0135727

(51) Int. Cl. G06F 3/038

(52) U.S. Cl. 345/213

(57) ABSTRACT

A display includes a timing controller and a source driver. The timing controller reflects a rule making a frame recognizable on a signal different from a gate start pulse (GSP) informing of a start of the frame and transmits the rule-reflected signal. The source driver receives the rule-reflected signal transmitted from the timing controller and checks the rule reflected on the rule-reflected signal to thereby recognize the frame. The rule is reflected on the signal different from the GSP to inform of frame start or frame change and the rule-reflected signal is transmitted to the source driver. Using the rule, the source driver can recognize frame start or frame change. Accordingly, there is an effect of eliminating a necessity of a change in hardware resources or provision of an additional hardware resource in the source driver for the recognition of frame start or frame change.

The present application claims priority under 35 U.S.C. §119 to Korean Patent Application No. 10-2008-0135727 (filed on Dec. 29, 2008), which is hereby incorporated by reference in its entirety.

### BACKGROUND

As a display such as a television or a monitor has an increased resolution, an increased amount of data must be transmitted to the display. For this reason, it is necessary to transmit data at an increased transmission rate.

However, when data is transmitted at a high transmission rate, electromagnetic interference (EMI) or radio frequency interference (RFI) may occur mainly in lines transmitting data signals between a timing controller and a column-driving integrated circuit such as a source driver.

In order to reduce such interference, a small-signal differential transmission method such as reduced swing differential signaling (RSDS) or mini-low voltage differential signaling (LVDS) is widely used. A gate start pulse (GSP), which is transmitted from a timing controller to inform of the start of a frame, is essentially needed in components associated with gate drivers. Of course, such a GSP is not needed in a source driver to drive data. However, the source driver may require a frame recognition signal when it uses a function to alternately apply offsets, and thus, to reduce the amount of offsets, in order to achieve an enhancement in picture quality, or in other situations.

In order to supply the GSP to the source driver for the above-mentioned reason, it may be necessary to provide additional hardware resources, for example, a printed circuit board (PCB) line and allocation of a pin to the source driver.

### SUMMARY

Embodiments relate to a display, and more particularly, to a display including a timing controller and a source driver, which are usable for a chip-on-glass (COG), chip-on-film (COF), or tape carrier package (TCP), and a communication method of the display.

Embodiments relate to a display and a communication method thereof, which are configured to enable a source driver to recognize change or start of a frame without any hardware assistance.

In accordance with embodiments, a display includes at least one of the following: a timing controller for reflecting a rule making a frame recognizable on a signal different from a gate start pulse (GSP) informing of a start of the frame, the timing controller transmitting the rule-reflected signal; and a source driver for receiving the rule-reflected signal transmitted from the timing controller and checking the rule reflected on the rule-reflected signal, thereby recognizing the frame.

In accordance with embodiments, a communication method of a display having a source driver and a timing controller includes at least one of the following: reflecting a rule making a frame recognizable on a signal different from a gate start pulse (GSP) informing of a start of the frame; and then transmitting the rule-reflected signal from the timing controller to the source driver, and receiving the rule-reflected signal transmitted from the timing controller by the source driver; and then checking the rule reflected on the rule-reflected signal, thereby recognizing the frame.

In accordance with embodiments, a communication method includes at least one of the following: providing a display having a source driver and a timing controller; reflecting a rule using the timing controller to make a frame recognizable on a signal different from a gate start pulse (GSP) informing of a start of the frame; transmitting the rule-reflected signal from the timing controller to the source driver; receiving the rule-reflected signal transmitted from the timing controller by the source driver; and then checking the rule reflected on the rule-reflected signal to thereby recognize the frame.

### DRAWINGS

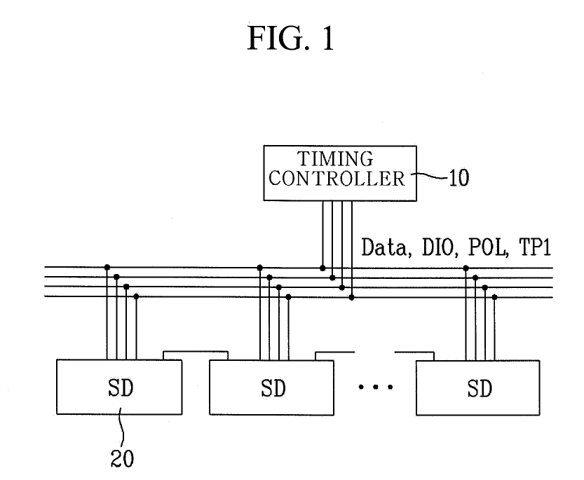

Example FIGS. 1-8 illustrates a display a communication method thereof, in accordance with embodiments.

### DESCRIPTION

As illustrated in example FIG. 1, the display in accordance with embodiments includes timing controller 10 and a plurality of source drivers 20.

The display in accordance with embodiments illustrated in example FIG. 1 and the communication method thereof are associated with communications between each source driver 20 and timing controller 10. In this regard, other elements, namely, gate drivers and a display panel, will be described in brief in the following description.

The display may further include gate drivers (or row-driving circuits) and a display panel. Timing controller 10 controls the gate drivers and source drivers 20. The gate drivers and source drivers 20 function to drive the display panel. The display panel serves to display an image in accordance with scan signals R1 to Rn supplied from the gate drivers, and data signals C1 to Cm supplied from source driver 20. The display panel may include various display panels usable between timing controller 10 and the display-driving integrated circuit (DDI), for example, LCD panels such as a thin film transistor liquid crystal display (TFT-LCD) panel and a super twisted nematic LCD (STN-LCD) panel, a plasma display panel (PDP), an organic light-emitting diode (OLED) display panel, and a field emission display (FED) panel.

Timing controller 10 may transmit to source drivers 20 various control signals to control source drivers 20 and data. The control signals may include a signal to inform of the start of data (hereinafter, referred to as a “signal DIO”), a latch enable signal to latch data transmitted from timing controller 10 (hereinafter, referred to as a “signal TP1”), and a signal to inform of the polarity of data transmitted from timing controller 10 to each source driver 20 (hereinafter, referred to as a “signal POL”).

Each source driver 20 receives synchronous data and control signals from timing controller 10. Where the interface between timing controller 10 and each source driver 20 is a reduced swing differential signaling (RSDS) interface, each source driver 20 receives the signal to inform of the start of data through a data input/output port. On the other hand, where the interface is a mini-low voltage differential signaling (LVDS) interface, each source driver 20 receives the signal to inform of the start of data through a data line. Timing controller 10 and each source driver 20 have an analysis rule agreed therebetween for signals transmitted for communications.

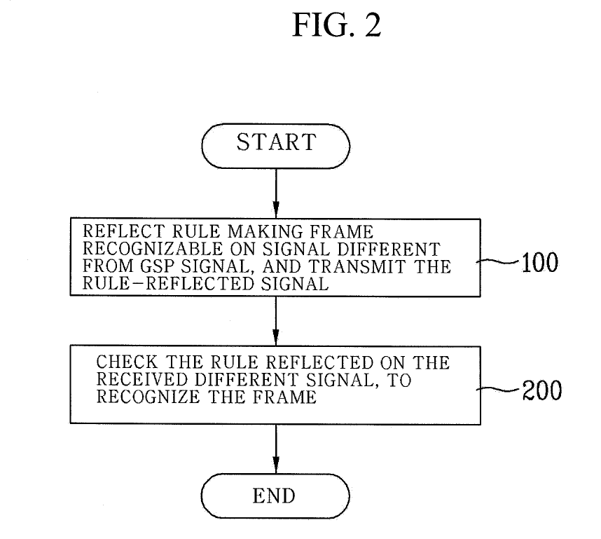

As illustrated in example FIG. 2, timing controller 10 reflects a rule enabling recognition of a frame on a signal different from a signal to inform of the start of the frame, namely, a gate start pulse (GSP), to transmit the rule, in place of transmitting the GSP (100). For example, in accordance with embodiments, timing controller 10 may reflect the rule on the blank time of the signal different from the GSP, and then may transmit the rule-reflected signal to source driver 20.

After execution of step 100, source driver 20 checks the rule reflected on the rule-reflected signal received by source driver 20, and recognizes the frame in accordance with the results of the checking (200). Here, the frame recognition may mean the recognition of frame start or the recognition of frame change. Where the rule is reflected on the blank time, source driver 20 analyzes the rule contained in the blank time, thereby recognizing the frame.

Hereinafter, embodiments including step 100 of reflecting a rule on the blank time of a signal, to transmit the rule, and step 200 of checking the blank time of the rule-reflected signal, to recognize the frame will be described.

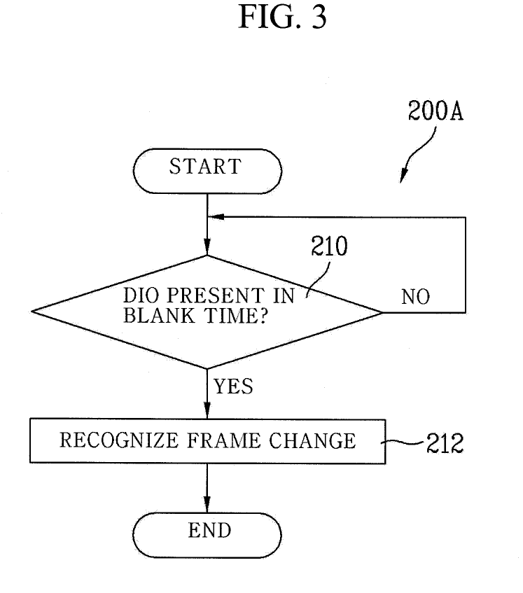

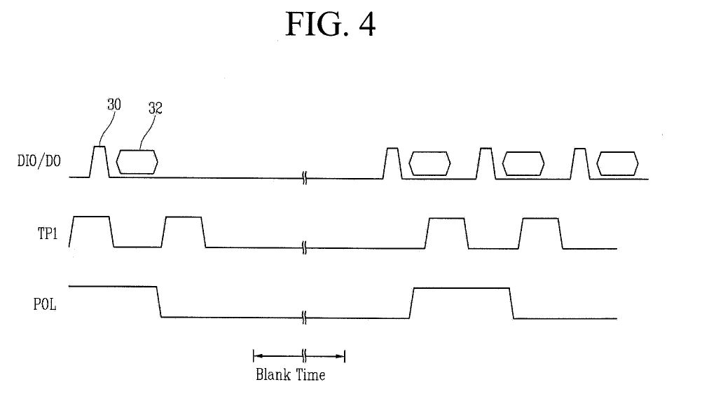

Example FIG. 3 is a flow chart illustrating an embodiment 200A of step 200 illustrated in example FIG. 2. Example FIG. 4 is a waveform diagram of signals used in accordance with embodiments illustrated in example FIG. 3.

In accordance with embodiments, timing controller 10 first executes step 100. That is, timing controller 10 reflects on a signal to be transmitted to source driver 20 a rule representing whether or not a DIO is inserted into the blank time of the signal, and then transmits the rule-reflected signal to source driver 20.

In the case of example FIG. 4, timing controller 10 transmits data (DO) 32 under the condition that data 32 is inserted into the signal, downstream from DIO 30. In this case, a rule that no DIO is inserted into the blank time is reflected. When the signal, on which the rule representing whether a DIO is inserted is reflected in accordance with embodiments, is transmitted from timing controller 10, source driver 20 receives the rule-reflected signal, and then determines whether a DIO is present in the blank time of the rule-reflected signal (210).

In accordance with embodiments, therefore, source driver 20 checks whether there is a DIO detected after a predetermined time elapses from detection of a previous DIO, during continuous checking of the blank time. When there is a DIO detected after the predetermined time, source driver 20 recognizes that frame change has occurred (212).

Where the interface between timing controller 10 and source driver 20 is a mini-LVDS interface, source driver 20 recognizes, as a DIO, a reset signal which is internally recognized through a data line for data DO.

It may be possible to achieve recognition of the rule-reflected signal by setting a rule that an alternating signal such as the TP1 or the POL is maintained at a “high” or “low” logical level in the blank time, different from the case of setting the rule that no DIO is inserted into the blank time.

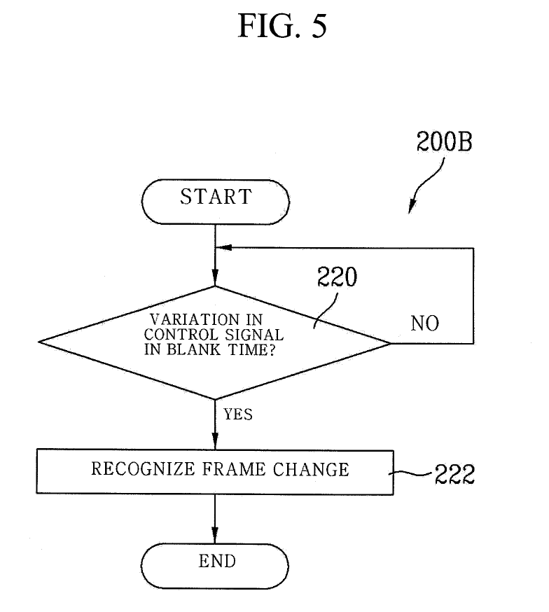

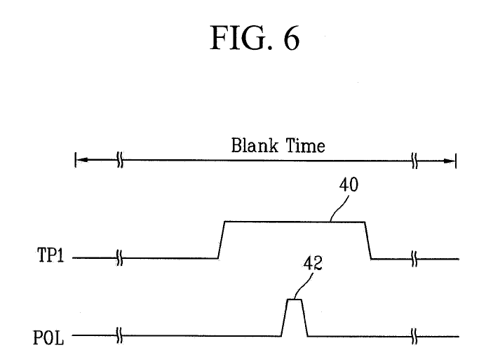

Example FIG. 5 is a flow chart illustrating another exemplary embodiment 200B of step 200 illustrated in example FIG. 2. Example FIG. 6 is a waveform diagram of signals used in accordance with embodiments illustrated in example FIG. 5.

In accordance with embodiments, a control signal generated from timing controller 10 to control source driver 20 is used as the rule-reflected signal. In this case, timing controller 10 varies the control signal in the blank time thereof, to reflect a rule on the control signal. Timing controller 10 then transmits the resultant control signal, namely, the rule-reflected signal, to source driver 20. Here, the control signal may be the TP1 or may be the POL. Also, the variation in the control signal may mean a variation in the level of the control signal.

For example, as illustrated in example FIG. 6, timing controller 10 may vary the TP1 such that the TP1 is maintained at a “high” logical level 40 in the blank time for a predetermined time, in order to enable source driver 20 to recognize frame change. Alternatively, timing controller 10 may vary the POL such that the POL is maintained at “high” logical level 42 in the blank time for a predetermined time,

When the rule-reflected signal, namely, the control signal TP1 or POL, on which the rule is reflected in accordance with embodiments, is transmitted from timing controller 10, source driver 20 receives the control signal TP1 or POL, and then determines whether the control signal TP1 or POL is varied in the blank time (220). When it is determined that the control signal TP1 or POL is varied in the blank time, source driver 20 recognizes that frame change has occurred (222). Meaning, source driver 20 recognizes that frame change has occurred, when the control signal TP1 or POL received by source driver 20 has a “high” logic level in the blank time, as illustrated in example FIG. 6.

Thus, in accordance with embodiments, the width of the signal TP1 or POL in the blank time is determined such that the signal TP1 or POL is maintained at a “high” logic level 40, 42 for a predetermined clock period or longer, as illustrated in example FIG. 6, different from the width thereof in the data driving time, in order to enable source driver 20 to recognize frame change by checking the “high” logic level 40, 42 in the blank time.

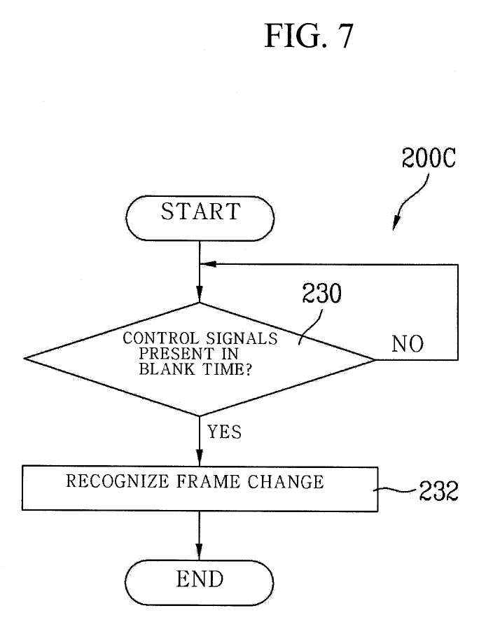

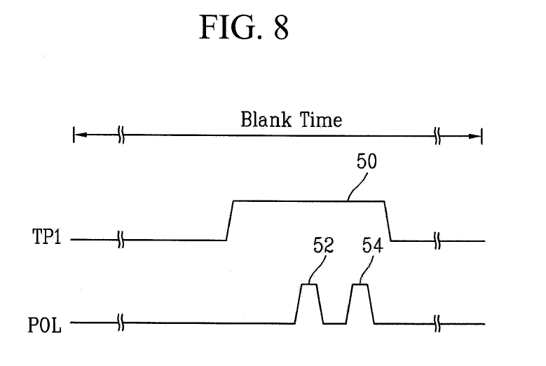

Example FIG. 7 is a flow chart illustrating embodiment 200C of step 200 illustrated in example FIG. 2. Example FIG. 8 is a waveform diagram of signals used in accordance with embodiments illustrated in example FIG. 7.

In accordance with embodiments, timing controller 10 combines control signals in the blank time, to set a desired rule, and then transmits the resultant signal, on which the set rule is reflected, namely, a rule-reflected signal. In this case, the rule-reflected signal includes the control signals generated from timing controller 10 to control source driver 20. The control signals may include the TP1 and POL as described above.

For example, as illustrated in example FIG. 8, timing controller 10 sets a rule, based on the number of input times of the control signal POL for a period of time in which control signal TP1 is maintained at a predetermined logic level in the blank time, combines the control signals TP1 and POL to reflect the rule thereon, and then transmits to source driver 20 the resultant signal including the rule-reflected control signals.

When the rule-reflected signal on which the rule is reflected in accordance with embodiments, is transmitted from timing controller 10, source driver 20 determines from the received rule-reflected signal whether the control signals are combined in the blank time (230).

For example, as illustrated in example FIG. 6, source driver 20 determines whether control signal POL is generated twice (“52” and “54”) during a period of time in which control signal TP1 is maintained at “high” logic level 50 in the blank time, namely, whether control signals POL and TP1 are combined in the blank time in accordance with the set rule. When it is determined that control signals POL and TP1 are combined in the blank time, source driver 20 recognizes frame change of the signal transmitted from timing controller 10. Thus, in accordance with embodiments, source driver 20 can recognize frame change from a combination of control signals TP1 and POL when control signal POL is input twice, namely, exhibits a “high” logic level twice, during a period of time in which the control signal TP1 is maintained at a “high” logic level in the blank time.

In the above-described communication method of the display in accordance with embodiments, the rule set by timing controller 10 is previously transmitted to source driver 20 in order to enable source driver 20 to recognize frame start or frame change. Meaning, both timing controller 10 and source driver 20 already know how the rule is to be set in order to achieve frame recognition.

As apparent from the above description, in the display and communication method thereof in accordance with embodiments, a predetermined rule is reflected on a signal different from a GSP signal informing of frame start or frame change, in order to inform of frame start or frame change, and the rule-reflected signal is transmitted to the source driver. Using the rule, the source driver can recognize frame start or frame change. Accordingly, there is an effect of eliminating a necessity of a change in hardware resources or provision of an additional hardware resource, for example, addition of lines and pins, in the source driver, for the recognition of frame start or frame change.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A display comprising:
a timing controller which reflects a rule making a frame recognizable on a signal different from a gate start pulse (GSP) which informs of a start of the frame, the timing controller transmitting the rule-reflected signal; and
a source driver which receives the rule-reflected signal transmitted from the timing controller, the source driver checking the rule reflected on the rule-reflected signal, thereby recognizing the frame.

2. A communication method of a display including a source driver and a timing controller, the communication method comprising:
reflecting a rule making a frame recognizable on a signal different from a gate start pulse (GSP) informing of a start of the frame, and transmitting the rule-reflected signal from the timing controller to the source driver; and then
receiving the rule-reflected signal transmitted from the timing controller by the source driver, and checking the rule reflected on the rule-reflected signal, thereby recognizing the frame.

3. The communication method of claim 2, wherein the start of the frame is recognized through the rule.

4. The communication method of claim 2, wherein a frame change into the frame is recognized through the rule.

5. The communication method of claim 2, wherein the rule is reflected on a blank time of the different signal.

6. The communication method of claim 5, wherein the rule represents whether a signal (DIO) informing of a start of data is inserted into the blank time of the different signal.

7. The communication method of claim 6, wherein recognizing the frame comprises:
determining whether the signal (DIO) is present in the blank time of the different signal transmitted from the timing controller; and then
recognizing a frame change into the frame when it is determined that the signal (DIO) is a DIO detected after a predetermined time elapses from detection of a previous DIO during continuous checking of the blank time.

8. The communication method of claim 5, wherein the different signal is a control signal used by the timing controller to control the source driver.

9. The communication method of claim 8, wherein the timing controller reflects the rule by varying the control signal in the blank time, and then transmits the rule-reflected control signal.

10. The communication method of claim 9, wherein the control signal is a latch enable signal (TP1) to enable the source driver to latch data.

11. The communication method of claim 9, wherein the control signal is a signal (POL) to inform of a polarity of data transmitted from the timing controller to the source driver.

12. The communication method of claim 9, wherein recognizing the frame comprises:
determining whether the control signal transmitted from the timing controller is varied in the blank time; and then
recognizing a frame change into the frame when it is determined that the control signal is varied in the blank time.

13. The communication method of claim 9, wherein the variation is a variation in a level of the control signal.

14. The communication method of claim 5, wherein the different signal comprises control signals used by the timing control to control the source driver.

15. The communication method of claim 14, wherein the timing controller reflects the rule on the different signal by combining the control signals in the blank time.

16. The communication method of claim 15, wherein the control signals comprise a latch enable signal (TP1) and a signal (POL) to inform of a polarity of data transmitted from the timing controller to the source driver.

17. The communication method of claim 16, wherein the rule represents a number of input times of the POL for a period of time in which the TP1 is maintained at a predetermined logic level.

18. The communication method of claim 16, wherein recognizing the frame comprises:
determining whether the control signals transmitted from the timing controller are combined in the blank time; and then
recognizing a frame change into the frame when it is determined that the control signals are combined.

19. A communication method comprising:
providing a display having a source driver and a timing controller;
reflecting a rule using the timing controller to make a frame recognizable on a signal different from a gate start pulse (GSP) informing of a start of the frame;
transmitting the rule-reflected signal from the timing controller to the source driver;
receiving the rule-reflected signal transmitted from the timing controller by the source driver; and then
checking the rule reflected on the rule-reflected signal to thereby recognize the frame.

20. The communication method of claim 19, wherein one of the start of the frame and a frame change is recognized through the rule.
